(19) United States
(12) Patent Application Publication
(10) Pub. No.: US 2010/0221574 A1
(43) Pub. Date: Sep. 2, 2010

(54) Zinc alloy mechanically deposited coatings and methods of making the same

(76) Inventor: Thomas H. Rochester, Jackson, MI (US)

Correspondence Address: BUTZEL LONG, 2190 Commons Parkway, Okemos, MI, 48864, US

(21) Appl. No.: 12/660,500

(22) Filed: Feb. 26, 2010

Related U.S. Application Data
(60) Provisional application No. 61/208,839, filed on Feb. 27, 2009.

(51) Int. Cl. B32B 15/02; B05D 1/12; C22C 18/00

(52) U.S. Cl. 428/658; 427/180; 420/513

(57) ABSTRACT

A process for forming a zinc alloy coating on a metallic substrate is disclosed. The process includes the steps of (a) reacting a mixture including (i) a zinc powder and (ii) an oxide, a salt, or a combination thereof of an alloying metal more noble than zinc by heating the mixture at an elevated temperature for a time sufficient to form a zinc alloy powder including zinc and the alloying metal; and (b) mechanically depositing the zinc alloy powder on the metallic substrate, thereby forming the zinc alloy coating on the metallic substrate. The zinc alloy powder includes relatively high levels of the alloying metal, resulting in the ability to incorporate relatively high levels of the same into the zinc alloy coating during the mechanical deposition step.

### CROSS-REFERENCE TO RELATED APPLICATION

This application claims priority to Provisional Application No. 61/208,839, filed Feb. 27, 2009, which is incorporated herein by reference in its entirety.

### BACKGROUND OF THE DISCLOSURE

1. Field of the Disclosure

The present disclosure relates to mechanical deposition processes, such as are employed to provide a sacrificial coating for metal parts. Such parts include nails, washers, bolts, screws, stampings, nuts, lock-rings, etc. The disclosure relates more particularly to mechanical processes for depositing a metal powder upon a metallic substrate, for example a zinc alloy powder on a ferrous substrate.

The process generally includes a reaction step in which a mixture including a zinc powder and an oxide/salt of an alloying metal more noble than zinc is heated at a temperature less than the melting point of zinc. As a result of the heating/reaction step, the alloying metal oxide/salt is reduced, and the alloying metal forms at least a binary alloy with zinc. The resulting zinc alloy is also in a powder form, thus facilitating its use as a coating powder in a subsequent mechanical deposition step. The zinc alloy powder can be a ternary (or higher) alloy, for example when more than one alloying metal oxide/salt is used and/or when the original zinc powder is itself an alloy (e.g., a zinc-aluminum alloy powder).

The zinc alloy powder, when used in a subsequent mechanical deposition step, results in a substantially higher level of incorporation of the alloying metal in the sacrificial coating as compared to other mechanical deposition processes.

2. Brief Description of Related Technology

Metal substrates, for example steel parts such as nails, screws, washers, etc., may be provided with a sacrificial coating to prevent corrosion of the substrate. A sacrificial coating (such as zinc) is chemically more active than the substrate it protects and, therefore, “sacrifices” itself to protect the substrate. The processes by which such coatings are applied include hot-dip galvanizing, mechanical deposition, electroplating, etc.

Mechanical deposition of zinc and other ductile metals (e.g., cadmium, tin, silver, copper, gold, zinc-cadmium mixtures, zinc-tin mixtures, and cadmium-tin mixtures) on a ferrous substrate can be performed by tumbling parts to be coated with impact media (e.g., glass beads) and a metal powder (e.g., zinc powder with a diameter of less than about 10 microns) in an aqueous acidic solution. These metallic particles of the powder are impacted against and thereby mechanically bonded to the surface of a metal substrate.

“Mechanical plating” is a term generally applied to mechanically deposited coatings ranging in thickness from about 0.1 mil to 1.0 mil (i.e., 0.0001 in or 2.54 μm to 0.001 in or 25.4 μm). Another class of mechanical deposition, known as “mechanical galvanizing,” is used to refer to the application of a thicker (e.g., from about 1 mil to 5 mil or 25.4 μm to 127 μm) and heavier (e.g., from about 0.7 oz/ft² to 2.3 oz/ft²) mechanically-applied metallic coatings. While mechanical galvanizing refers to zinc deposits, mechanical plating may generally refer to any metal or mixture amenable to plating by this method.

Mechanical plating has the advantages that it does not produce hydrogen embrittlement of the plated articles and also that the energy costs involved in carrying out mechanical plating are generally comparatively low. Accordingly, mechanical plating has found increasing use for plating small metal articles such as screws, bolts, nails, nuts, washers, lock-rings, stampings and the like.

Automotive and other industrial applications have continued to demand increasingly effective corrosion protection. Since corrosion-resistant deposits typically last many years in the external environmental conditions, accelerated tests are generally used to predict and quantify the improved service life of coatings. The most common of these accelerated tests is the ASTM B 117 Salt Spray (Fog) test. In this test, the articles provided with a protective coating are exposed to an essentially neutral salt fog consisting of 5% sodium chloride and 95% water for a period of time. The time to failure is then measured. The measured parameters are the percentage of the surface covered with white corrosion products of zinc (generally called ‘white rust’) and base metal corrosion (for iron and steel, ‘red rust’).

### Objects

One of the objects is to provide a mechanical deposition process that produces an article with improved corrosion resistance, particularly when compared with the typical mechanically plated article of commerce, which has a deposit comprising approximately 95% zinc and approximately 5% tin, with the tin being provided to the coating by the promoter or accelerator formulations used. Accordingly, it would be desirable to provide a zinc alloy powder with increased levels of alloying metals that result in an increased level of the alloying metals being incorporated into the coating of the final plated article, thereby improving the corrosion resistance of the same.

Another object is to provide a means of producing a zinc alloy deposit that does not introduce hydrogen embrittlement into articles that have been heat-treated to produce additional strength, as an alternative to electroplating. Articles heat treated to a Rockwell hardness of over R_{C} 32 (equivalent to a tensile strength of 145,000 psi or 999 MPa) are commonly considered susceptible to premature tensile failure due to hydrogen embrittlement if electroplated.

Yet another object is to provide a means for producing ternary, quaternary, quintenary, hexanary, heptanary, octanary, and higher alloys for specific purposes.

These and other objects may become increasing apparent by reference to the following description.

### SUMMARY

The disclosure relates to a process for forming a zinc alloy coating on a metallic substrate. The process includes the steps of (a) reacting a mixture comprising (i) a zinc powder and (ii) an oxide, a salt, or a combination thereof of an alloying metal (e.g., an alloying metal that is more noble than zinc and/or that has an atomic radius that is compatible with the atomic radius of zinc) by heating the mixture at a temperature ranging from about 300° F. to about 700° F. for a time sufficient to form a zinc alloy powder comprising zinc and the alloying metal; and (b) mechanically depositing the zinc alloy powder on the metallic substrate, thereby forming the zinc alloy coating on the metallic substrate. In an embodiment, step (b) of the foregoing process can be omitted, resulting in a suitable process for the formation of the zinc alloy powder. In another embodiment, the coating process can include the steps of (a) providing the mechanical deposition powder already formed according to any of the disclosed embodiments of the above reaction step; and (b) mechanically depositing the zinc alloy powder on a metallic substrate, thereby forming a zinc alloy coating on the metallic substrate. In certain embodiments, the reaction temperature ranges from about 300° F. to about 650° F., about 450° F. to about 700° F., about 450° F. to about 650° F., or about 300° F. to about 600° F. The reaction temperature can be substantially constant during the reaction, and the reaction time can suitably range from about 0.25 hr to about 12 hr, about 0.5 hr to about 9 hr, or about 1 hr to about 6 hr. Preferably, the reaction mixture is agitated while heating. The mechanical deposition step can be performed at ambient temperature (e.g., ranging from about 50° F. to about 100° F. or about 60° F. to about 90° F.). In an embodiment, the mechanical deposition step comprises agitating the zinc alloy powder, the metal substrate, and impact media in an acidic liquid environment (e.g., pH less than about 4 or ranging from about pH 0 to about pH 4).

In any embodiment, the zinc powder can consist essentially of metallic zinc. Alternatively, the zinc powder can comprise an alloy of zinc and at least one secondary alloying metal (e.g., zinc-aluminum alloy powder). Preferably, the zinc powder comprises particles having a size ranging from about 0.2 μm to about 100 μm (or about 1 μm to about 20 μm) and having an average size ranging from about 2 μm to about 20 μm (or about 5 μm to about 10 μm). In an embodiment, the resulting zinc alloy powder has size distribution properties substantially corresponding to those of the original zinc powder (e.g., having a breadth and/or average in the foregoing ranges).

The alloying metals that are more noble than zinc are not particularly limited, generally including any metal having an electrode potential (P(V)) of oxidation less than that of zinc. Alternatively or additionally, the alloying metal can have an atomic radius ranging from about 85% to about 115% (e.g., at least about 85%, 90%, or 95% and/or up to about 95%, 100%, 105%, 110% or 115%) relative to the atomic radius of zinc. The alloying metals can comprise at least one of cadmium, chromium, cobalt (preferable), copper, gold, iron (preferable), lead, manganese, molybdenum, nickel (preferable), palladium, silver, and tin. The salt of the alloying metal can include a halide salt (e.g., chloride salt), a sulfate salt, and/or hydrates thereof. The alloying metal, when in the form of a salt or oxide, can suitably be in any of its common oxidation states (e.g., Ni(II) and Ni(III) in NiO and Ni₂O₃, Fe(II) and Fe(III) in FeO, Fe₂O₃,and Fe₃O₄). Preferably, the alloying metal oxide/salt is in the form of a powder having a smaller size distribution relative to that of the zinc powder, for example a nanopowder. The nanopowder can comprise particles having a size ranging from about 0.2 nm to about 500 nm (or about 1 nm to about 100 nm) and having an average size ranging from about 2 nm to about 100 nm (or about 5 nm to about 50 nm).

In any embodiment, the metallic substrate can comprise a ferrous metal or alloy thereof (e.g., steel) and can be in the shape of nails, washers, bolts, screws, stampings, nuts, and/or lock-rings. The metallic substrate can more generally include a base metallic substrate that has been pretreated to include other layers prior to deposition of the zinc alloy powder. In an embodiment, (i) the metallic substrate comprises: (A) a base metallic substrate, (B) an immersion copper coating on the base metallic substrate, and (C) a tin flash coating on the immersion copper coating; and (ii) the zinc alloy powder is deposited on the tin flash coating as the zinc alloy coating. In another embodiment, (i) the metallic substrate comprises: (A) a base metallic substrate, and (B) a tin flash coating on the base metallic substrate; and (ii) the zinc alloy powder is deposited on the tin flash coating as the zinc alloy coating. In the final plated article, the zinc alloy coating on the metallic substrate preferably comprises the alloying metal in an amount ranging from about 0.5 wt. % to about 20 wt. % (e.g., about 1 wt. % to about 15 wt. %, about 2 wt. % to about 15 wt. %, or about 4 wt. % to about 15 wt. %) based on the combined weight of zinc and all alloying metals in the zinc alloy powder.

The disclosure also relates to a plated article comprising a zinc alloy-coated metallic substrate resulting from the coating process of any one of the foregoing embodiments, for example as illustrated in FIG. 1 in cross-sectional view. In FIG. 1, a plated article 100 includes a metallic substrate 110 onto which a zinc alloy coating 120 is layered. The zinc alloy coating 120 includes zinc alloyed with any of the foregoing described alloying (and possible secondary alloying) metals, for example Zn—Ni, Zn—Cr, Zn—Co, Zn—Cu, Zn—Fe, Zn—Al—Ni, Zn—Al—Fe, and/or Zn—Co—Fe—Ni. As illustrated, the metallic substrate 110 includes a base metallic substrate 112 (e.g., a ferrous substrate in the shape of an article to be plated (nails, washers, etc.)) onto which an optional immersion copper coating 114 and an optional tin flash coating 116 are sequentially layered. As formed, each of the layers formed in the plated article 100 is a discrete layer. Over time, diffusion at the interfacial boundary between adjacent layers can result in the formation of additional intermetallic compounds (e.g., the formation of a Sn—Cu alloy from the immersion copper coating 114 and the tin flash coating 116).

The disclosure also relates to a mechanical deposition powder including the zinc alloy powder resulting from the reaction step of any of the foregoing embodiments as well as a process for making the same (i.e., a process including the reaction step but without necessarily including the mechanical deposition step). Preferably, the zinc alloy powder comprises the alloying metal in an amount ranging from about 0.5 wt. % to about 20 wt. % (e.g., about 1 wt. % to about 15 wt. %, about 2 wt. % to about 15 wt. %, or about 4 wt. % to about 15 wt. %, such as at least about 5 wt. %, 6 wt. %, 8 wt. % or 10 wt. % and/or up to about 15 wt. % or 20 wt. %) based on the combined weight of zinc and all alloying metals in the zinc alloy powder. More specifically, the weight basis includes elemental zinc and other metals alloyed with zinc in the zinc alloy, but excludes other metals coated prior to the zinc alloy powder (e.g., tin flash coating, copper immersion coating) and other oxides/salts present in the zinc alloy powder (e.g., unreacted alloying metal oxides/salts, zinc oxide/salt by-products). In an embodiment, the mechanical deposition powder further includes an oxidized zinc by-product selected from the group consisting of zinc oxides, zinc salts, and combinations thereof. The mechanical deposition powder can comprise the oxidized zinc by-product in an amount ranging from about 0.5 wt. % to about 20 wt. % (e.g., about 1 wt. % to about 15 wt. %, about 2 wt. % to about 15 wt. %, or about 4 wt. % to about 15 wt. %) based on the combined weight of zinc and all alloying metals in the zinc alloy powder.

All patents, patent applications, government publications, government regulations, and literature references cited in this specification are hereby incorporated herein by reference in their entirety. In case of conflict, the present description, including definitions, will control.

Additional features of the disclosure may become apparent to those skilled in the art from a review of the following detailed description, taken in conjunction with the examples, drawings, and appended claims, with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 illustrates a cross-sectional view of a plated article formed according to the disclosed coating process.

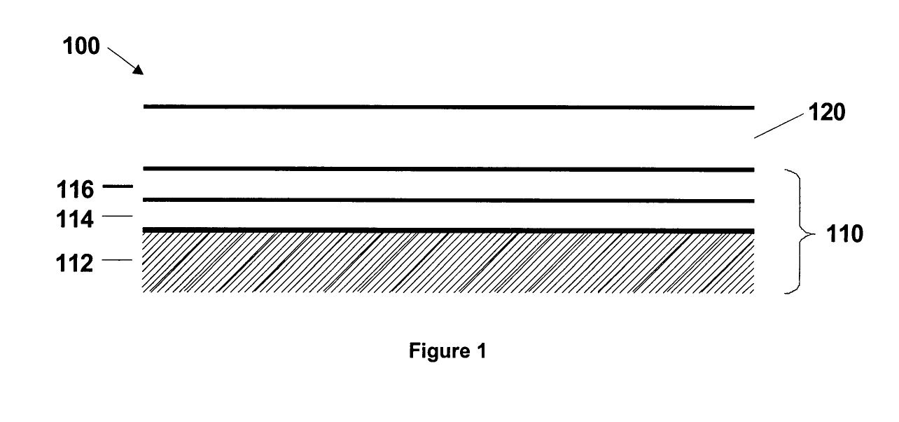

While the disclosed compositions and methods are susceptible of embodiments in various forms, specific embodiments of the disclosure are illustrated in the drawings (and will hereafter be described) with the understanding that the disclosure is intended to be illustrative, and is not intended to limit the claims to the specific embodiments described and illustrated herein.

### DETAILED DESCRIPTION

The present disclosure relates to a process for forming a zinc alloy coating on a metallic substrate. The process includes the steps of (a) mixing (i) a zinc powder and (ii) an oxide, a salt, or a combination thereof of an alloying metal more noble than zinc and reacting the mixture by heating the mixture at an elevated temperature (e.g., ranging from about 300° F. to about 700° F.) for a time sufficient to form a zinc alloy powder including zinc and the alloying metal; and (b) mechanically depositing the zinc alloy powder on the metallic substrate, thereby forming the zinc alloy coating on the metallic substrate.

Also disclosed is a mechanical deposition powder including the zinc alloy powder resulting from the foregoing reaction step (a). The disclosure further relates to a plated article including a zinc alloy-coated metallic substrate resulting from the foregoing mechanical deposition step (b). The zinc alloy powder includes relatively high levels of the alloying metal(s), resulting in the ability to incorporate relatively high levels of the same into the zinc alloy coating during the mechanical deposition step, in particular relative to conventional mechanical deposition processes for providing a zinc alloy coating.

### Zinc Alloy Formation

A mechanical deposition process for depositing a zinc alloy powder on a metal substrate to form a sacrificial coating therefor is described. The zinc alloy powder includes a powder produced by reacting zinc powder or dust with an oxide or a salt of an alloying metal more noble than zinc. The powder thus produced is an alloy of zinc and the more noble metal. As used herein, the term “alloy” refers to an intentional mixture of two or more metals. The reaction/reduction process is performed at an elevated temperature (e.g., at least about 300° F., at least about 450° F., or at least about 550° F.), preferably as close to the melting point of zinc (about 787° F.) as the ultimate goal of producing a fine particulate product will allow. In some cases and depending on the particular metals being alloyed with zinc, particle fusion may begin to occur even at temperatures less than the melting point of zinc. Accordingly, it can be desirable to perform the reaction/reduction process at temperatures less than the melting point of zinc (e.g., about 725° F. or less, about 700° F. or less, about 675° F. or less, or about 650° F. or less). Powder particle fusion can undesirably limit the ability to mechanically deposit the zinc alloy powder in a subsequent step. For example, suitable temperature ranges include: about 300° F. to about 675° F., about 300° F. to about 650° F., about 300° F. to about 600° F., about 450° F. to about 675° F., or about 450° F. to about 650° F. Nanoparticulate oxides and salts of the alloying metal are preferred in this process, presumably because there is more intimate contact with the zinc powder particles, which generally average 6 to 8 microns in diameter. The zinc powder can be essentially entirely composed of elemental zinc (e.g., at least about 95 wt. %, 98 wt. %, or 99 wt. %); alternatively, the particles of the zinc powder can themselves be an alloy of zinc and at least one secondary alloying metal (e.g., a zinc-aluminum alloy) prior to reaction. The alloying metal oxide/salt can include more than one alloying metal, oxide thereof, and/or salt thereof. For example, the alloying metal oxide/salt can include a mixture of nickel oxide and iron oxide that, upon reaction with the zinc powder, results in a Zn—Ni—Fe ternary alloy powder for mechanical deposition.

One means of achieving improved corrosion potential is to utilize a zinc alloy coating in place of the relatively pure zinc coatings historically utilized. The improved corrosion protection of a zinc alloy coating (whether electrodeposited, mechanically deposited, or deposited in some other fashion) can be attributed to its electrode potential (E^{o}(V)), as the electrode potential of oxidation of the second alloying component (and third, fourth, etc. alloying components, if present) is lower than that of zinc, as shown in Table 1A below:

TABLE 1A
Oxidation-Reduction Potentials in Acid Solutions (from Latimer)

| Element - Ion Couple | E° (V) |
|---|---|
| Zn = Zn⁺⁺ + 2e⁻ | +0.76 |
| Cr = Cr⁺⁺⁺ + 3e⁻ | +0.74 |
| Fe = Fe⁺⁺ + 2e⁻ | +0.44 |
| Cd = Cd⁺⁺ + 2e⁻ | +0.40 |
| Co = Co⁺⁺ + 2e⁻ | +0.28 |
| Ni = Ni⁺⁺ + 2e⁻ | +0.25 |
| Mo = Mo⁺⁺⁺ + 3e⁻ | +0.20 |
| Sn = Sn⁺⁺ + 2e⁻ | +0.14 |
| Pb = Pb⁺⁺ + 2e⁻ | +0.13 |
| Cu = Cu⁺⁺ + 2e⁻ | −0.34 |
| Ag = Ag⁺ + e⁻ | −0.80 |
| Pd = Pd⁺⁺ + 2e⁻ | −0.99 |
| Au = Au⁺⁺⁺ + 3e⁻ | −1.50 |

The relative chemical potentials at the elevated temperatures used to fire/react the zinc powder mixture with the salts or oxides of alloying metals more noble than zinc may vary somewhat from those obtained experimentally in acid solution and listed in Table 1, but the same general order is assumed to be maintained. As used herein, a metal more noble than zinc is one whose oxide or salt is reduced in the presence of zinc when heated in the reaction step (e.g., E^{o}_{noble metal}<E^{o}_{zinc}). Examples of suitable alloying metals more noble than zinc include cadmium, chromium, cobalt, copper, gold, iron, lead, molybdenum, nickel, palladium, silver, and tin, with metals such as chromium, cobalt, copper, iron, molybdenum, and nickel being preferred.

Without wishing to be bound by any specific theory, it is believed that the reaction step is a thermally reductive, thermally reactive step that proceeds approximately as follows: Zinc powder particles are thoroughly mixed with a finely divided alloying metal salt or oxide resulting in intimate contact of the components. Then at an elevated temperature, the zinc particles, being electrochemically more reactive than the alloying metal salt/oxide with which they are mixed, reduce the salt or oxide to the more noble alloying metal. This more noble alloying metal then thermally diffuses with the zinc, forming a zinc alloy particle that is amenable to the mechanical deposition process. For example, a mixture of zinc powder and nickel oxide nanopowder (e.g., as described in Example 1, below) reacts to form a Zn—Ni alloy powder that also generally includes zinc oxide (e.g., a reaction by-product) and potentially includes residual nickel oxide (e.g., an unconsumed reactant). The zinc alloy powder is capable of producing a deposit with a significant noble alloying metal content; Example 1 is illustrative in this regard with a zinc to nickel ratio of 10.66 to 1 (w/w). By way of contrast, the addition of a metal salt or oxide to the mechanical plating process at room temperature results in minimal codeposition of the salt-containing solution, resulting in quite high ratios of zinc to noble metal (i.e., a relatively low level of incorporation of the noble metal), which substantially limits the effectiveness of the alloying noble metal to improve corrosion resistance. For example, in U.S. Pat. No. 5,587,006 there is described a zinc-tin-nickel deposit in which the ratio of zinc to nickel is at best more than about 13,000:1 (w/w).

Alternatively or additionally, the alloying metal can be selected such that it has an atomic radius that is close to/compatible with the atomic radius of zinc. Without being bound to any specific theory, it is believed that elements having an atomic radius close to that of zinc are more amenable to the disclosed alloying process. More specifically, the atomic radius of the alloying metal suitably ranges from about 85% to about 115% relative to the atomic radius of zinc (e.g., ranging from about 114 μm to about 154 μm), for example having an atomic radius of at least about 85%, 90%, or 95% and/or up to about 95%, 100%, 105%, 110%, or 115% relative to that of zinc. Atomic radii of suitable alloying metals are provided in Table 1B below:

TABLE 1B
Atomic Radii

| | Atomic | Atomic |
|---|---|---|
| Element | Number | Radius (pm) |
| Chromium (Cr) | 24 | 128 |
| Manganese (Mn) | 25 | 127 |
| Iron (Fe) | 26 | 127 |
| Cobalt (Co) | 27 | 125 |
| Nickel (Ni) | 28 | 124 |
| Zinc (Zn) | 30 | 134 |
| Silver (Ag) | 47 | 137 |
| Cadmium (Cd) | 48 | 151 |
| Tin (Sn) | 50 | 132 |

### Copper Immersion Coating

Preferably, an intermediate deposit of immersion copper (or flash copper) is applied to the metallic substrate prior to depositing the zinc alloy powder. Articles to be plated are tumbled with glass beads (impact media) and a strong, inhibited acid (almost always sulfuric acid or hydrochloric acid; other acids have either technical or economic disadvantages or both). A copper salt is then added, resulting in displacement of the iron by copper, giving a bright, tightly adherent deposit of copper metal that functions as a base for the subsequently applied coatings. Liquid and dry preparations are commercially available from various manufacturers for this purpose, which can contain from 1 to 100% of an acidic copper compound (e.g., copper sulfate). Liquid formulations normally also contain the acid (e.g., sulfuric acid or hydrochloric acid). Dissolved copper from the acidic-water solution readily plates onto the clean metal surfaces of the metallic substrate by reacting with the surface, resulting in a galvanic copper layer (e.g., less than about 1 μm thick, or about 0.2 μm to about 0.3 μm thick) applied to the surface of the substrate.

### Tin Flash Coating

Preferably, an intermediate deposit of electroless tin (or flash tin) is applied to the metallic substrate prior to depositing the zinc alloy powder. In some embodiments, the immersion copper coating is first applied to the metallic substrate, the electroless tin coating is then applied to the immersion copper coating, and the zinc alloy powder is finally mechanically deposited onto the electroless tin coating. In other embodiments, the immersion copper coating is omitted, and the electroless tin coating is applied directly onto the metallic substrate.

Advantageously, this electroless tin deposit is achieved by reacting soluble stannous salts with zinc dust as taught by Golben in U.S. Pat. No. 3,400,012. Suitable ductile metal salts or salt-engendering compounds (e.g., oxides) are selected from the group consisting of stannous oxide, stannous chloride, and stannous sulfate. The electroless tin is galvanomechanically applied by the reduction of stannous tin to tin metal by the reaction with finely divided zinc dust (or other “driving” metal) under acidic conditions, for example as disclosed in Golben U.S. Pat. No. 3,400,012 (“Golben '012”). Golben '012 describes a galvanomechanical plating process in which a driving metal and an ionizable salt of the metal to be plated are added to the plating liquid. The driving metal selected is one which is less noble than the plating metal or the metal of the metallic surfaces to be plated, and therefore functions as a chemical reducing agent.

The deposit of the zinc alloy (or zinc alone) in the subsequent mechanical deposition process is “promoted” or “accelerated” by the presence of stannous tin and tin metal. Preferably, the tin flash coating is applied in an amount of about 5 wt. % (e.g., about 1 wt. % to about 10 wt. %, or about 3 wt. % to about 7 wt. %), based on the combined amount of tin flash and subsequent zinc alloy plated on the substrate.

### Mechanical Deposition of Zinc Alloy

Broadly speaking, in mechanical deposition processes, metal parts to be plated are tumbled in a suitable rotating vessel, such as a mill or barrel, together with impact media and a ductile metal powder and, optionally and preferably, one or more substances designed to make the surface of the metal parts more amenable to deposition of the metal powder. The metallic substrate of the parted to be plated are generally ferrous metals, but other metals and metal alloys (e.g., brass) can be plated. Deposition of the sacrificial layer occurs through a process generally known as “cold welding” in the impact energy of the impact media mechanically bonds the metal powder to the surface of the metal parts, as well as to itself, until a desired thickness is achieved. Overviews of the conventional form of the mechanical plating process may be found in Wynn et al., “Mechanical Plating,” Products Finishing, pp. 74-79 (October 2001); “Mechanical Plating,” Plating and Surface Finishing, pp. 16-19 (July 2007); and Satow, “Mechanical Plating and Galvanizing,” Metal Finishing Guidebook and Directory 2008/2009, pp. 315-322, the disclosures of which are incorporated herein by reference in their entirety.

The impact media used are preferably made of glass (although other forms of impact media are possible). The impact media are generally in the form of spherical glass beads, usually from 4 U.S. Mesh (0.187 in or 4.75 mm) up to approximately 100 mesh (0.0059 in or 150 μm). Typically, the one or more optional substances include “promoter” or “accelerator” compositions as well as an acid to facilitate the deposition. In the mechanical plating process, the acid continually removes the oxide from the surface to the particles to be plated so that intimate metal-to-metal contact is achieved during the actual mechanical plating process.

The mechanical plating process by which the zinc alloy powder particles are deposited onto a metallic substrate may be conducted in the presence of a strong acid or in the presence of a weak organic acid. A “strong acid” is an acid that is nearly completely disassociated at room temperature in aqueous solution. Particularly preferred strong acids for mechanical plating and mechanical galvanizing are hydrochloric acid (muriatic acid) and sulfuric acid. (Sulfuric acid, being diprotic, is completely disassociated from only one hydronium ion, and the hydrolysis is somewhat complex.) When strong acids are used in the mechanical deposition process, inhibitors are preferably used to slow the rate of the reaction between the strong acid and the zinc powder. A “weak organic acid” is an organic acid with a dissociation constant of less than about 10⁻³. Suitable weak organic acids include such as tartaric, succinic, glycolic, citric, malic, malonic or the like. In general, dibasic acids are preferred in the process over monobasic acids, and citric acid, which is tribasic, is especially preferred. The mechanical deposition process may also be conducted in a mixture of strong and weak organic acids.

### Examples

The following examples illustrate the disclosed compositions and methods, but are not intended to limit the scope of any claims thereto. Unless otherwise noted, the examples which were generally carried out according to the following methodology:

The parts to be plated were conventionally cleaned in a hot alkaline cleaner so as to be relatively free from organic contamination. The cleaned parts were thereafter loaded into a small polypropylene mechanical plating barrel. Such barrels are typically made from or lined with plastic or a corrosion-resistant elastomer, and are commonly hexagonal or octagonal in shape, although the particular plating barrel employed in the process of this invention is not intended as limiting. Impact media was also loaded into the plating barrel. The impact media used was, per convention, spherical or roughly spherical glass beads of varying dimensions ranging from approximately 4 U.S. Mesh to approximately 60 U.S. Mesh. Roughly equal amounts, by volume, of impact media and parts to be plated were loaded into the plating barrel. However, this ratio of impact media to parts is variable according to such considerations as the weight of the parts to be plated or the thickness of the sacrificial coating to be applied, all as known to those of skill in the art. By way of non-limiting example, galvanizing a 2 mil thick coating commonly requires a 2 to 1 ratio of impact media to parts, respectively.

Next, water was introduced into the plating barrel and the level thereof adjusted appropriate to the parts to be plated, as is known to those familiar with the art. The barrel temperature was also adjusted to approximately 72° F. according to known practices.

An acidic inhibited detergent cleanser was added to the plating barrel and the barrel thereafter rotated until the parts were free from surface oxide, all as per conventional practice.

A copper salt was subsequently introduced into the plating barrel, the copper salt reacting with the ferrous substrate in the presence of a strong inhibited acid to produce a tightly adherent immersion copper coating on the parts. This copper coating served as a base for the subsequent mechanical deposition as described below.

A stannous (tin) salt or stannous oxide was next added to the plating barrel and allowed to dissolve to form stannous ions. Thereafter, a quantity of so-called “driving metal” powder was introduced to act as a reducing agent. Suitable “driving metals” include metals more active than tin, and specifically, metals that will reduce stannous tin to tin metal in an acidic environment at room temperature. In this methodology, zinc was used as the “driving metal,” and a thin deposit of tin formed on the surface of the metal parts. Along with the driving metal, dispersants, inhibitors, and surfactants were introduced into the plating barrel, per conventional practice.

### Example 1

900 g of zinc dust (Grade M515, obtained from Purity Zinc Metals, 290 Arvin Avenue, Stoney Creek, Ontario, Canada L8E 2M1) were thoroughly mixed with 100 g of Nickel Oxide (nanopowder, <50 nm, obtained from Aldrich Chemical Co., Milwaukee, Wis.). The mixture was wrapped in aluminum foil and placed in an oven in which the temperature was set at 650° F. After an hour, the wrapped mixture was removed from the oven and allowed to cool. The mixture was pulverized and the fraction passing through a 100 mesh screen was used for plating as follows.

A small, oblique polypropylene plating barrel was loaded with 2000 cubic centimeters (cc) of glass impact media of the following dimensions and amounts: 50% by weight of approximately 5 mm diameter (0.1969 in); 25% by weight of approximately 10 to 14 U.S. Mesh (0.0555 in to 0.0787 in or 1.40 mm to 2.00 mm); 12.5% by weight of approximately 16 to 25 U.S. Mesh (0.0278 in to 0.0469 in or 710 μm to 1.18 mm); and 12.5% by weight of approximately 40 to 60 U.S. Mesh (0.0098 in to 0.0165 in or 250 μm to 425 μm).

Thereafter, the plating barrel was loaded with 5 lb of ⅜ in×1¾ in partially threaded hex bolts and 2 lb of ⅜ in Type A Plain Washers (0.406 in ID, 0.812 in OD, 0.065 in thick). The total surface area in the barrel was believed to be approximately 3.72 ft². The parts loaded to the barrel had previously been cleaned with a conventional alkaline detergent cleaner at an elevated temperature and rinsed.

To the foregoing was added 11 ml of inhibited acidic detergent cleaner, and the parts were tumbled in the plating barrel at approximately 25 rpm for 15 minutes to remove the oxide film on the surface of the parts. Thereafter, 1 g of copper sulfate and 2 g of salt were added to produce a bright immersion copper deposit.

Following creation of the immersion copper deposit, the parts were rinsed three times, and 3 g of a promoter compound formulated as set forth in Table 2, below, was introduced.

TABLE 2
Promoter Composition for Example 1

| Component | Amount | |
|---|---|---|
| Citric Acid (available commercially from Cargill, | 81.98% | w/w |
| Minnetonka, MN) | | |
| Stannous Sulfate (available commercially from Mason | 10% | w/w |
| Chemicals, Schererville, IN) | | |
| PEG 20000 (available commercially from PCC Chemax, | 5% | w/w |
| Greenville SC) | | |
| Mannich Reaction Product R | 1% | w/w |
| Triphenylsulfonium Chloride, 50% in water (available | 0.01% | w/w |
| commercially from City Chemical Co., West Haven CT) | | |
| Butoxyne 497 (available commercially from International | 0.01% | w/w |
| Specialty Products, Wayne, NJ) | | |
| Diatomaceous Earth | 2% | w/w |

The Mannich Reaction Product R of Table I is synthesized as follows: To 23.4 g of dehydroabietyl amine (Amine D, available from Ashland Chemical) was slowly added 7.5 g of acetophenone (Aldrich Chemical), with stirring; 10 g of 20 Baume Hydrochloric (Muriatic) Acid was added slowly in the same manner. Next, 9.7 g of 37% formaldehyde (Aldrich Chemical) was added in small increments, and the mixture refluxed intermittently at 80° C. over a period of three days. Thereafter, 25.0 g of acetone was added directly and 9.5 g of formaldehyde was added incrementally, continuing to reflux for an additional 24 hr. To the resultant crude product of this process was added 25 g of isopropanol and 25 g of nonionic polyoxyethylene adduct of nonylphenol (generically, NP-9, available as Igepal CO-730 from Rhodia, Cranbury, N.J.).

Following introduction of the promoter compound, the barrel was tumbled for 1 minute, and then 1 g of Purity Zinc Grade M515 was added (i.e., as the driving metal) and the barrel tumbled again for three minutes. In this manner, the parts were flashed with a thin deposit of electroless tin and the parts achieved a silvery appearance as a base for the subsequent deposition of metal through mechanical means.

Subsequently, 35 g of the above zinc alloy powder above was added to the plating barrel over a 15 min period, divided into 5 roughly equal portions.

Following the addition of the foregoing, the plating barrel was tumbled for about twenty minutes, while maintaining the pH of the solution below 3.5 with the intermittent addition of citric acid. The plated parts were thereafter removed from the plating barrel, separated from the media, rinsed thoroughly, and dried in a small centrifugal dryer.

Upon inspection, the plated parts of this first example were found to have a uniform deposit of plated metal of approximately 0.000406 in or 10.3 μm.

Several of these parts were stripped in a hydrochloric acid solution and submitted for analysis by atomic absorption to determine the alloy composition of the coating. The coating (excluding the tin, which as discussed above, is present in all mechanically produced deposits) was 9.38% nickel, with the balance zinc.

Subsequent evaluation of the thus plated and passivated parts was conducted by placing a number of the plated parts in a salt spray chamber of conventional construction, wherein the parts were exposed to a salt fog per ASTM B-117-04. These parts exhibited failure (being defined hereafter as over 5% base metal corrosion) at 120 hr. Comparative articles coated with unalloyed zinc (other than tin) lasted 96 hr to failure.

Still others of the thus-plated parts were, following plating as described, treated with a 10% solution of PAVCO HYPROBLUE (available from Pavco, 1935 John Crosland Jr. Drive, Charlotte, N.C.), a trivalent passivate (or a “trivalent chromate”). Trivalent passivates function by generating hexavalent chromium in small quantities during the corrosion process, especially during the salt spray test. These parts were introduced to a salt spray cabinet as described above and after 1500 hr exhibited no base metal corrosion (red rust).

Still others of these plated parts were treated with a solution consisting of 0.375% by weight Chromic Acid (CrO₃, obtained from Elementis Specialties, Hightstown, N.J.) and 0.375% Sodium Chloride (common salt, NaCl, obtained from Cargill) for a period of 20 seconds, producing a conventional yellow chromate conversion coating on the surface of the parts. The parts were then rinsed with tap water, and, without drying, immersed in a room temperature solution of 12.5% by volume Sodium Silicate (SiO₂:Na₂O ratio of 3.22:1, available as “O Grade” from Haviland Products, Grand Rapids, Mich.) and dried in a centrifugal dryer without further rinsing. These parts were introduced to the Salt Spray Cabinet, as above, and after 1000 hr were removed for inspection, and showed no base metal corrosion, after which the test was terminated.

### Example 2

The mixing, firing, and plating processes of Example 1 were repeated, firing a mixture of 50 g of chromium oxide (Cr₂O₃) and 950 g of zinc dust. Analysis of the resulting deposit (as done in example 1) showed the deposit (again excluding the tin) to be 0.49% chromium. It is believed that the level of incorporation of the chromium in the deposit could be increased if the mixture of chromium oxide and zinc were agitated during the firing process. The thickness of the deposit obtained was measured by magnetic induction to be approximately 0.00024 in (6.1 μm). Evaluation by salt spray indicated that the untreated parts lasted 120 hr. Parts treated with the above Pavco trivalent passivate lasted 888 hr in the salt spray test.

### Example 3

The mixing, firing, and plating processes of Example 1 were repeated, firing a mixture of 100 g of cobalt oxide (CoO) and 900 g of zinc dust. Analysis of the resulting deposit showed the deposit (again excluding the tin) to be 0.59% cobalt.

### Example 4

Example 1 was repeated, firing a mixture of 100 g of copper oxide (CuO) and 900 g of zinc dust. Analysis of the resulting deposit showed the deposit (again excluding the tin) to be 4.23% copper.

### Example 5

Example 1 was repeated, firing a mixture of 100 g of nickel oxide (NiO) with 900 g of atomized zinc-aluminum powder (available commercially from Umicore, Broekstraat 31 rue de Marias, B-1000 Brussels, Belgium), and is produced from the atomization of a molten alloy of zinc and aluminum. This powder comprises about 13% aluminum and about 87% zinc, and is characterized by particles ranging from about 6 μm to 10 μm in diameter. Analysis of the resulting deposit showed the deposit (excluding tin) to be comprised of 29.36% aluminum, 0.42% nickel and 70.22% zinc.

### Example 6

Example 1 was repeated, firing 10 g of Iron Oxide (Fe₃O₄; 20-30 nm nanopowder obtained from Aldrich Chemical) with 90 g of zinc dust. Analysis of the resulting deposit, as described in Example 1, showed the deposit (excluding tin) to contain 89.00% zinc and 11.00% iron.

### Examples 7-10

For Examples 7-10, Example 1 was repeated (i.e., using a mixture of 900 g of zinc dust and 100 g of nickel oxide (NiO)) at the range of temperatures indicated in Table 3. The resultant alloy compositions in Table 3 were obtained by plating the parts as above and stripping the deposit with hydrochloric acid. From the data, there is a direct proportionality (e.g., relatively linear relationship) between the between the firing temperature and the resulting concentration of the alloying metal in the zinc alloy.

TABLE 3
Effect of Firing Temperature on Incorporation of Alloying Metal

| | Firing | Nickel Amount |
|---|---|---|
| | Temperature | (wt. %; balance Zn, |
| Example | (° F.) | excluding Sn) |
| Example 7 | 300° F. | 0.06% |
| Example 8 | 375° F. | 1.10% |
| Example 9 | 450° F. | 3.91% |
| Example 10 | 550° F. | 7.56% |
| Example 1 | 650° F. | 9.38% |

### Examples 11-12

For Example 11, 1 g of nickel oxide (NiO) and 99 g of zinc dust, as above, were wrapped in aluminum foil and fired at 650° F. for one hour. After firing, the metal mixture was ground and used as the plating metal as above. The resultant alloy composition was 0.15% nickel, with the balance being zinc.

For Example 12, 1 g of nickel oxide (NiO) and 99 g of zinc dust, as above, were loaded to a small stainless steel container. The container was placed in an oven and rotated at a firing temperature of 650° F. for one hour. After this firing cycle, the resultant powder (which was found to be free-flowing and unagglomerated) was removed and used as the plating metal as described above. The resultant alloy contained 0.35% nickel, with the balance (excluding tin) being zinc.

Comparing and contrasting Examples 11 and 12 would indicate that active mixing during the firing cycle (e.g., rotating in a container or otherwise agitating while being heated) is preferred, as it tends to result in a higher fraction of the more noble metal (e.g., nickel in Examples 11 and 12) being incorporated into the zinc alloy that is eventually deposited onto the metallic substrate.

### Example 13

5 g of cobalt oxide (COO) and 95 g of zinc dust, as above in Example 1, were loaded to a small stainless steel container. The container was placed in an oven and rotated at a firing temperature of 650° F. for one hour. After this firing cycle, the resultant powder (which was found to be free-flowing and unagglomerated) was removed and used as the plating metal as described as in Example 1, with the exception that the cleaning solution was not rinsed from the plating barrel and 1 g of the following promoter formulation were used:

TABLE 4
Promoter Composition for Example 13

| Component | Amount |
|---|---|
| Stannous Sulfate (available commercially from Mason | 79% w/w |
| Chemicals, Schererville, IN) | |
| PEG 20000 (available commercially from PCC Chemax, | 15% w/w |
| Greenville SC) | |
| Mannich Reaction Product R (from Example 1) | 1.5% w/w |
| Witcamine RAD 1100 (available commercially from | 1.5% w/w |
| Crompton Corp., Greenwich CT) | |
| Diatomaceous Earth | 3.0% w/w |

Example 13 illustrates the ability to eliminate the rinsing step and re-use the acid from the cleaning step in the tin flash plating step and the zinc alloy mechanical deposition step. The resultant alloy contained 0.35% cobalt, with the balance (excluding tin) being zinc.

### Example 14 (Comparative)

The plating process set forth in Example 1 was repeated, with unalloyed zinc dust replacing the zinc alloy powder. The deposit thickness was 0.000225 in (5.71 μm). Washers and hex head machine screws from this experimental run were placed in the Salt Spray cabinet and after 96 hr they exhibited in excess of 5% red rust or base metal corrosion.

### Example 15 (Illustrative)

In a beaker, a solution of 250 ml of 3% cobalt chloride hexahydrate (Aldrich), 5% by volume hydrochloric acid (22° Baume; from Haviland Products, Grand Rapids, Mich.), 0.1% Miranol JS (a corrosion inhibitor; available from Rhodia), and 0.1% Igepal CO-730 (a wetter and leveler) was prepared. Following the disclosure of Golben U.S. Pat. No. 3,400,012, a previously immersion-coppered steel test panel (1 in×4 in) was dipped into the solution, and 1 g of zinc dust was added. After mixing, the test panel was inspected and the copper coating was still visible, indicating that no reduction or electroless deposition of cobalt had occurred.

### Example 16 (Illustrative)

In a beaker, a solution of 250 ml of 3% nickel sulfate hexahydrate (Aldrich), 5% by weight Sulfuric Acid (66° Baume, from Haviland Products), 0.1% Miranol JS (a corrosion inhibitor), and 0.1% Igepal CO-730 (a wetter and leveler) was prepared. A previously immersion-coppered steel test panel (1 in×4 in) was dipped into the solution, and 1 g of zinc dust was added. After mixing, the test panel was inspected and the copper coating was still visible, indicating that no reduction or electroless deposition of nickel had occurred.

### Example 17

1 g of cobalt oxide (CoO), 3 g of iron oxide (Fe₃O₄; 20-30 nm nanopowder obtained from Aldrich Chemical), 1 g of nickel oxide (NiO), and 95 g of zinc dust, as above, were loaded to a small stainless steel container. The container was placed in an oven and rotated at a firing temperature of 650° F. for one hour. After this firing cycle, the resultant powder (which was found to be free-flowing and unagglomerated) was removed and used as the plating metal as described above in Example 1.

Analysis of the resulting deposit by atomic absorption showed the deposit to contain 0.014% cobalt, 2.46% iron, 0.76% nickel, and 96.77% zinc (i.e., excluding tin that was unanalyzed but present in the deposit as well). Thus, Example 17 illustrates the ability to alloy zinc with more than one alloying metal and mechanically deposit the resulting alloy. The deposit thickness was 0.000225 in (5.71 μm). Washers and hex head machine bolts from this experimental run were treated with PAVCO HYPROBLUE, and tested per ASTM B-117, all as in Example 1, and failed at 888 hr.

### Example 18

Example 1 was repeated, firing a mixture of 50 g of iron oxide (Fe₃O₄; 20-30 nm nanopowder) with 950 g of atomized zinc-aluminum powder as per Example 5. Analysis of the resulting coating by atomic absorption showed the deposit to contain 7.07% aluminum, 0.42% iron, and 92.51% zinc, there being unanalyzed tin in the deposit as well. The deposit thickness was measured at 0.000504 in (12.80 μm) by magnetic induction. Washers and hex head machine bolts from this experimental run were treated with PAVCO HYPROBLUE, and tested per ASTM B-117, all as in Example 1, and failed at 888 hr.

### Example 19

Example 1 was repeated, except that the amount of zinc-nickel alloy added to the plating barrel over a 25-minute period for mechanical deposition was 85 g (i.e., compared to the 35 g from Example 1), after which the parts were rinsed. Small amounts of the promoter formulation set forth in Example 1 were added incrementally to maintain the pH below 3.5. Analysis of the resulting deposit by atomic absorption showed the deposit to contain 0.41% nickel, excluding tin. The deposit thickness was measured at 0.001122 in (28.45 μm) by magnetic induction.

### Example 20

10 g of cobalt oxide (CoO) and 90 g of zinc dust, as above, were loaded to a small stainless steel container. The container was placed in an oven and rotated at a firing temperature of 650° F. for one hour. After this firing cycle, the resultant powder (which was found to be free-flowing and unagglomerated) was removed and used as the plating metal as described in Example 1, except that the immersion coppering step was eliminated. Under favorable process conditions, the immersion coppering step may be eliminated if the coating thickness is under approximately 0.001 in and the promoter formulation is optimized for this process. After cleaning and removal of the scale with an inhibited sulfuric acid-based cleaner, the parts were rinsed thoroughly, and 3 g of the following promoter formulation added.

TABLE 5
Promoter Composition for Example 20

| Component | Amount |
|---|---|
| Tartaric Acid (Aldrich) | 42.5% w/w |
| Citric Acid | 42.5% w/w |
| Stannous Chloride (Anhydrous) (available from Mason | 10.0% w/w |
| Chemical, Schererville, IN) | |
| PEG 20000 | 5.0% w/w |

After the promoter had mixed in the plating barrel for one minute, 1 g of zinc dust (as above) was added. After the parts had achieved the silvery color of electroless tin, 35 g of the zinc-cobalt alloy powder were added incrementally over a period of 15 minutes, and the experimental procedure in Example 1 was followed thereafter. Analysis of the coating by atomic absorption showed the deposit to contain 5.90% cobalt and 94.1% zinc, there being unanalyzed tin in the deposit as well.

### Example 21

A sample of nickel chloride hexahydrate was dried at 650° F. for 24 hr, after which it was ground with a mortar and pestle. 5 g of this material and 95 g of zinc dust, as above, were loaded to a small stainless steel container. The container was placed in an oven and rotated at a firing temperature of 650° F. for one hour. After this firing cycle, the resultant powder (which was found to be free-flowing and unagglomerated) was removed and used as the plating metal as described above in Example 1. The resultant alloy contained 2.40% nickel, with the balance (excluding tin) being zinc.

### Example 22

Example 1 was repeated, lengthening the firing cycle to 6 hr at 650° F. The resultant alloy contained 15.00% nickel, with the balance (excluding tin) being zinc.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

Throughout the specification, where the compositions, processes, or apparatus are described as including components, steps, or materials, it is contemplated that the compositions, processes, or apparatus can also comprise, consist essentially of, or consist of, any combination of the recited components or materials, unless described otherwise. Combinations of components are contemplated to include homogeneous and/or heterogeneous mixtures, as would be understood by a person of ordinary skill in the art in view of the foregoing disclosure.

What is claimed is:

1. A coating process comprising:
(a) reacting a mixture comprising (i) a zinc powder and (ii) an oxide, a salt, or a combination thereof of an alloying metal more noble than zinc by heating the mixture at a temperature ranging from about 300° F. to about 700° F. for a time sufficient to form a zinc alloy powder comprising zinc and the alloying metal; and
(b) mechanically depositing the zinc alloy powder on a metallic substrate, thereby forming a zinc alloy coating on the metallic substrate.

2. The process of claim 1, wherein the zinc powder consists essentially of metallic zinc.

3. The process of claim 1, wherein the zinc powder comprises an alloy of zinc and at least one secondary alloying metal.

4. The process of claim 3, wherein the zinc powder comprises a zinc-aluminum alloy.

5. The process of claim 1, wherein the zinc powder comprises particles having a size ranging from about 1 μm to about 20 μm and having an average size ranging from about 5 μm to about 10 μm.

6. The process of claim 1, wherein the alloying metal comprises at least one of cadmium, chromium, cobalt, copper, gold, iron, lead, manganese, molybdenum, nickel, palladium, silver, and tin.

7. The process of claim 1, wherein the alloying metal comprises at least one of chromium, cobalt, copper, iron, molybdenum, and nickel.

8. The process of claim 1, wherein the alloying metal has an atomic radius ranging from about 85% to 115% relative to the atomic radius of zinc.

9. The process of claim 1, wherein the alloying metal comprises at least one of cobalt, iron, and nickel.

10. The process of claim 1, wherein the salt of the alloying metal comprises at least one of a halide salt and a sulfate salt.

11. The process of claim 1, wherein the oxide, salt, or combination thereof of the alloying metal is in the form of a nanopowder.

12. The process of claim 11, wherein the nanopowder comprises particles having a size ranging from about 1 nm to about 100 nm and having an average size ranging from about 5 nm to about 50 nm.

13. The process of claim 1, wherein the reaction temperature ranges from about 300° F. to about 650° F.

14. The process of claim 1, wherein the reaction step (a) further comprises agitating the mixture while heating.

15. The process of claim 1, wherein the reaction time sufficient to form the zinc alloy powder ranges from about 0.25 hr to about 12 hr.

16. The process of claim 1, wherein the reaction temperature is substantially constant during the reaction time sufficient to form the zinc alloy powder.

17. The process of claim 1, wherein the zinc alloy powder comprises particles having a size ranging from about 1 μm to about 20 μm and having an average size ranging from about 5 μm to about 10 μm.

18. The process of claim 1, wherein the metallic substrate comprises one or more of nails, washers, bolts, screws, stampings, nuts, and lock-rings.

19. The process of claim 1, wherein the metallic substrate comprises a ferrous metal or alloy thereof.

20. The process of claim 1, wherein the zinc alloy coating comprises the alloying metal in an amount ranging from about 0.5 wt. % to about 20 wt. % based on the combined weight of zinc and all alloying metals in the zinc alloy powder.

21. The process of claim 1, further comprising performing the mechanical deposition step (b) at an ambient temperature.

22. The process of claim 1, wherein the mechanical deposition step (b) comprises agitating the zinc alloy powder, the metal substrate, and impact media in an acidic liquid environment.

23. The process of claim 22, wherein the acidic liquid environment has a pH less than about 4.

24. The process of claim 1, wherein:
(i) the metallic substrate comprises: (A) a base metallic substrate, (B) an immersion copper coating on the base metallic substrate, and (C) a tin flash coating on the immersion copper coating; and
(ii) the zinc alloy powder is deposited on the tin flash coating as the zinc alloy coating.

25. The process of claim 1, wherein:
(i) the metallic substrate comprises: (A) a base metallic substrate and (B) a tin flash coating on the base metallic substrate; and
(ii) the zinc alloy powder is deposited on the tin flash coating as the zinc alloy coating.

26. A plated article comprising a zinc alloy-coated metallic substrate resulting from the coating process of claim 1.

27. A mechanical deposition powder comprising:
(a) a zinc alloy powder formed by a process comprising: reacting a mixture comprising (i) a zinc powder and (ii) an oxide, a salt, or a combination thereof of an alloying metal more noble than zinc by heating the mixture at a temperature ranging from about 300° F. to about 700° F. for a time sufficient to form a zinc alloy powder comprising zinc and the alloying metal.

28. The mechanical deposition powder of claim 27, wherein the zinc alloy powder comprises the alloying metal in an amount ranging from about 0.5 wt. % to about 20 wt. % based on the combined weight of zinc and all alloying metals in the zinc alloy powder.

29. The mechanical deposition powder of claim 27, further comprising:
(b) an oxidized zinc by-product selected from the group consisting of zinc oxides, zinc salts, and combinations thereof;
wherein the mechanical deposition powder comprises the oxidized zinc by-product in an amount ranging from about 0.5 wt. % to about 20 wt. % based on the combined weight of zinc and all alloying metals in the zinc alloy powder.

30. A coating process comprising:
(a) providing the mechanical deposition powder of claim 27; and
(b) mechanically depositing the zinc alloy powder on a metallic substrate, thereby forming a zinc alloy coating on the metallic substrate.
